(19) United States
(12) Patent Application Publication
(10) Pub. No.: US 2009/0002280 A1
(43) Pub. Date: Jan. 1, 2009

(54) ORGANIC LIGHT EMITTING DEVICE AND METHOD OF DRIVING THE SAME

(76) Inventors: Seungtae Kim, Seoul (KR); Homin Lim, Seoul (KR); Woong Joo, Seoul (KR); Hanjin Bae, Seoul (KR)

Correspondence Address: KED & ASSOCIATES, LLP, P.O. Box 221200, Chantilly, VA, 20153-1200, US

(21) Appl. No.: 12/014,993

(22) Filed: Jan. 16, 2008

(30) Foreign Application Priority Data
Jun. 26, 2007 (KR) 10-2007-0063087

(51) Int. Cl. G09G 3/30

(52) U.S. Cl. 345/76

(57) ABSTRACT

An organic light emitting device and a method of driving the same are disclosed. The organic light emitting device includes a display unit including a pixel including a plurality of subpixels, a scan driver connected to the display unit to supply a scan signal to the pixel, a data driver connected to the display unit to supply a data signal to the pixel, a switch unit positioned between one output terminal of the data driver and the subpixel, and a controller supplying a control signal for controlling turn-on/off operations of the switch unit to the switch unit. The switch unit includes a plurality of switches. One of the plurality of switches is turned on during an n-th scan period, maintained in a turn-on state, and turned off during an (n+1)-th scan period.

This application claims the benefit of Korean Patent Application No. 10-2007-0063087 filed on Jun. 26, 2007, which is hereby incorporated by reference.

### BACKGROUND

1. Field

An exemplary embodiment relates to a display device, and more particularly, to an organic light emitting device.

2. Description of the Related Art

An organic light emitting device is a self-emitting device including a light emitting layer between two electrodes.

The organic light emitting device may have a top emission structure and a bottom emission structure depending on an emission direction of light. The organic light emitting device may be classified into a passive matrix type organic light emitting device and an active matrix type organic light emitting device depending on a driving manner.

In the active matrix type organic light emitting device, when signals are supplied to a plurality of subpixels arranged on a display unit in a matrix format, a transistor, a capacitor, and an organic light emitting diode, which are positioned inside each subpixel, are driven to display an image. The active matrix type organic light emitting device uses a scan driver and a data driver to select each of the plurality of subpixels and to supply a data signal to the selected subpixels.

As an example of a method for supplying the data signal to the selected subpixels, there is a Mux driving manner in which a plurality of Mux switches are positioned between a data line outside the display unit and one output terminal of the data driver. The Mux driving manner uses three Mux switches to supply R, G, B data signals to the display unit.

In the Mux driving manner, when a scan signal starts to be supplied to the subpixels, the three Mux switches positioned on each of R, G, B data lines successively perform switch operations to supply the R, G, B data signals to the corresponding subpixels.

However, in the Mux driving manner, because a portion of a previous data signal remains in the signal lines, the portion of the previous data signal and the next data signal are mixed with each other or interfere with each other to thereby cause a reduction in the display quality. Further, because the Mux switches repeatedly perform the switch operations in every scan period, stress of the Mux switches may increase by their repeated switch operations

### SUMMARY

An exemplary embodiment provides an organic light emitting device capable of improving the display quality by efficiently supplying a data signal.

In one aspect, an organic light emitting device comprises a display unit including a pixel including a plurality of subpixels, a scan driver that is connected to the display unit to supply a scan signal to the pixel during a scan period, a data driver that is connected to the display unit to supply a data signal to the subpixels, a switch unit positioned between one output terminal of the data driver and the subpixels, the switch unit including a plurality of switches, wherein one of the plurality of switches is turned on during an n-th scan period, maintained in a turn-on state, and turned off during an (n+1)-th scan period, and a controller that supplies a control signal for controlling turn-on/off operations of the switch unit to the switch unit.

In another aspect, a method of driving an organic light emitting device comprises supplying a scan signal to a pixel including a plurality of subpixels during a scan period, supplying a plurality of control signals for selecting each of the plurality of subpixels during the scan period, and supplying a data signal to the subpixels while the plurality of control signals is supplied to the subpixels, wherein one of the plurality of control signals is continuously supplied to the subpixels during an n-th scan period and an (n+1)-th scan period.

### BRIEF DESCRIPTION OF THE DRAWINGS

The accompanying drawings, which are included to provide a further understanding of the invention and are incorporated on and constitute a part of this specification, illustrate embodiments of the invention and together with the description serve to explain the principles of the invention. In the drawings:

FIG. 1 is a bock diagram of an organic light emitting device according to an exemplary embodiment;

FIG. 2 is a schematic plane view of the organic light emitting device;

FIGS. 3A and 3B are circuit diagrams of a subpixel of the organic light emitting device;

FIG. 4 is a circuit diagram showing a structure of a plurality of switch units between a data driver and a pixel;

FIG. 5 is a diagram showing a first example of a driving waveform;

FIG. 6 is a diagram showing a second example of a driving waveform;

FIG. 7 is a diagram showing a third example of a driving waveform;

FIG. 8 is a plane view showing a structure of a subpixel of the organic light emitting device;

FIGS. 9A and 9B are cross-sectional views taken along line I-I′ of FIG. 8;

FIGS. 10A to 10C illustrate various implementations of a color image display method in the organic light emitting device; and

FIG. 11 is a cross-sectional view of the organic light emitting device.

### DETAILED DESCRIPTION

Reference will now be made in detail embodiments of the invention examples of which are illustrated in the accompanying drawings.

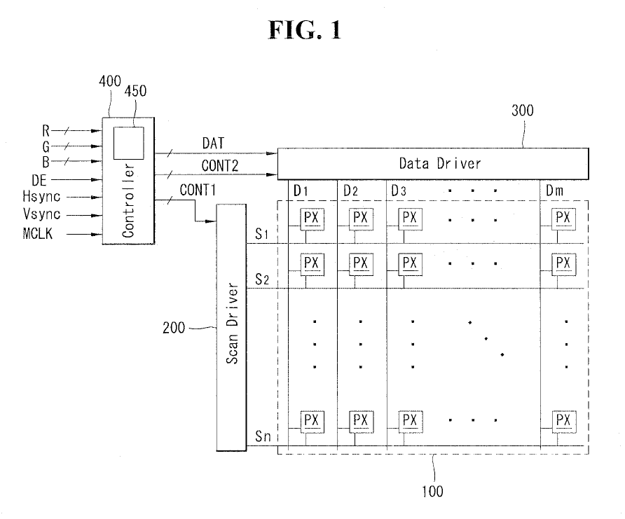

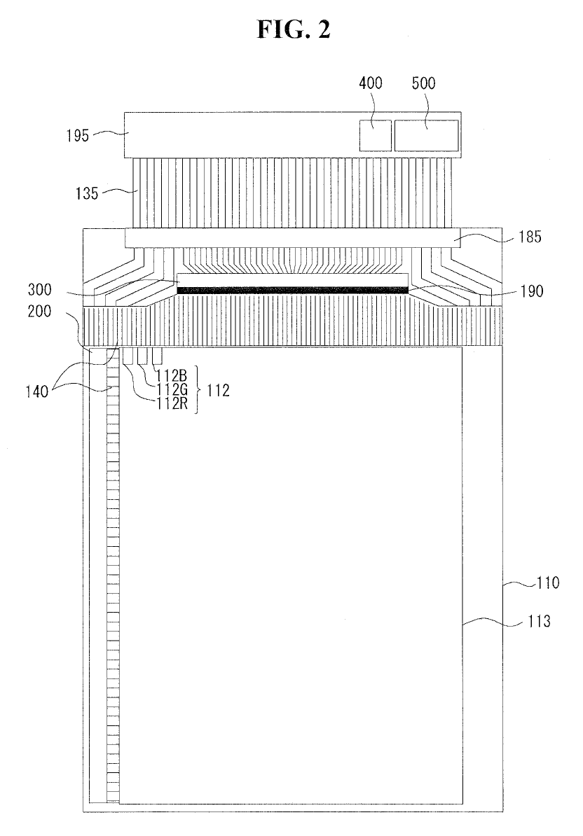

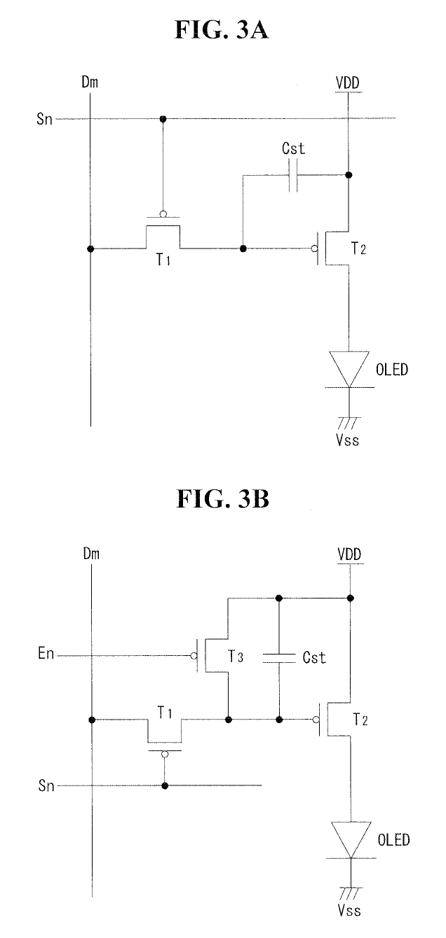

FIG. 1 is a bock diagram of an organic light emitting device according to an exemplary embodiment, FIG. 2 is a schematic plane view of the organic light emitting device, and FIGS. 3A and 3B are circuit diagrams of a subpixel of the organic light emitting device.

As shown in FIG. 1, the organic light emitting device according to the exemplary embodiment includes a display panel 100, a scan driver 200, a data driver 300, and a controller 400.

The display panel 100 includes a plurality of signal lines S1 to Sn and D1 to Dm, a plurality of power supply lines (not shown), and a plurality of subpixels PX arranged in a matrix format to be connected to the signal lines S1 to Sn and D1 to Dm and the power supply lines.

The plurality of signal lines S1 to Sn and D1 to Dm may include the plurality of scan lines S1 to Sn for transmitting scan signals and the plurality of data lines D1 to Dm for transmitting data signals. Each power supply line may transmit voltages such as a power voltage VDD to each subpixel PX.

Although the signal lines include the scan lines S1 to Sn and the data lines D1 to Dm in FIG. 1, the exemplary embodiment is not limited thereto. The signal lines may further include erase lines (not shown) for transmitting erase signals depending on a driving manner.

However, the erase lines may not be used to transmit the erase signals. The erase signal may be transmitted through another signal line. For instance, although it is not shown, the erase signal may be supplied to the display panel 100 through the power supply line in case that the power supply line for supplying the power voltage VDD is formed.

As shown in FIG. 3A, the subpixel PX may include a switching thin film transistor T1 transmitting a data signal in response to a scan signal transmitted through the scan line Sn, a capacitor Cst storing the data signal, a driving thin film transistor r2 producing a driving current corresponding to a voltage difference between the data signal stored in the capacitor Cst and the power voltage VDD, and a light emitting diode (OLED) emitting light corresponding to the driving current.

As shown in FIG. 3B, the subpixel PX may include a switching thin film transistor T1 transmitting a data signal in response to a scan signal transmitted through the scan line Sn, a capacitor Cst storing the data signal, a driving thin film transistor T2 producing a driving current corresponding to a voltage difference between the data signal stored in the capacitor Cst and the power voltage VDD, a light emitting diode (OLED) emitting light corresponding to the driving current, and an erase switching thin film transistor T3 erasing the data signal stored in the capacitor Cst in response to an erase signal transmitted through an erase line En.

When the display device is driven in a digital driving manner that represents a gray scale by dividing one frame into a plurality of subfields, the pixel circuit of FIG. 3B can control a light emitting time by supplying the erase signal to the subfield PX whose the light-emission time is shorter than an addressing time. The pixel circuit of FIG. 3B has an advantage capable of reducing a minimum luminance of the display device.

A difference between driving voltages, e.g., the power voltages VDD and Vss of the organic light emitting device may change depending on the size of the display panel 100 and a driving manner. A magnitude of the driving voltage is shown in the following Tables 1 and 2. Table 1 indicates a driving voltage magnitude in case of a digital driving manner, and Table 2 indicates a driving voltage magnitude in case of an analog driving manner.

TABLE 1

| | VDD-Vss | | |
|---|---|---|---|
| Size (S) of display panel | (R) | VDD-Vss (G) | VDD-Vss (B) |
| S < 3 inches | 3.5-10 (V) | 3.5-10 (V) | 3.5-12 (V) |
| 3 inches < S < 20 | 5-15 (V) | 5-15 (V) | 5-20 (V) |
| inches | | | |
| 20 inches < S | 5-20 (V) | 5-20 (V) | 5-25 (V) |

TABLE 2

| Size (S) of display panel | VDD-Vss (R, G, B) |
|---|---|
| S < 3 inches | 4~20 (V) |
| 3 inches < S < 20 inches | 5~25 (V) |
| 20 inches < S | 5~30 (V) |

Referring again to FIG. 1, the scan driver 200 is connected to the scan lines S1 to Sn to apply scan signals capable of turning on the switching thin film transistor T1 to the scan lines S1 to Sn, respectively.

The data driver 300 is connected to the data lines D1 to Dm to apply data signals indicating an output video signal DAT′ to the data lines D1 to Dm, respectively. The data driver 300 may include at least one data driving integrated circuit (IC) connected to the data lines D1 to Dm.

The data driving IC may include a shift register, a latch, a digital-to-analog (DA) converter, and an output buffer which are connected to one another in the order named.

When a horizontal sync start signal (STH) (or a shift clock signal) is received, the shift register can transmit the output video signal DAT′ to the latch in response to a data clock signal (HLCK). In case that the data driver 300 includes a plurality of data driving ICs, a shift register of a data driving IC can transmit a shift clock signal to a shift register of a next data driving IC.

The latch memorizes the output video signal DAT′, selects a gray voltage corresponding to the memorized output video signal DAT′ in response to a load signal, and transmits the gray voltage to the output buffer.

The DA converter selects the corresponding gray voltage in response to the output video signal DAT and transmits the gray voltage to the output buffer.

The output buffer outputs an output voltage (serving as a data signal) received from the DA converter to the data lines D1 to Dm, and maintains the output of the output voltage for 1 horizontal period (1H).

The controller 400 controls operations of the scan driver 200 and the data driver 300. The controller 400 may include a signal conversion unit 450 that gamma-converts input video signals R, G and B into the output video signal DAT′ and produces the output video signal DAT′.

The controller 400 produces a scan control signal CONT1 and a data control signal CONT2, and the like. Then, the controller 400 outputs the scan control signal CONT1 to the scan driver 200 and outputs the data control signal CONT2 and the processed output video signal DAT′ to the data driver 300.

The controller 400 receives the input video signals R, G and B and an input control signal for controlling the display of the input video signals R, G and B from a graphic controller (not shown) positioned outside the organic light emitting device. Examples of the input control signal include a vertical sync signal Vsync, a horizontal sync signal Hsync, a main clock signal MCLK and a data enable signal DE.

Each of the driving devices 200, 300 and 400 may be directly mounted on the display panel 100 in the form of at least one IC chip, or may be attached to the display panel 100 in the form of a tape carrier package (TCP) in a state where the driving devices 200, 300 and 400 each are mounted on a flexible printed circuit film (not shown), or may be mounted on a separate printed circuit board (not shown). Alternatively, each of the driving devices 200, 300 and 400 may be integrated on the display panel 100 together with elements such as the plurality of signal lines S1 to Sn and D1 to Dm or the thin film transistors T1, T2 and T3.

Further, the driving devices 200, 300 and 400 may be integrated into a single chip. In this case, at least one of the driving devices 200, 300 and 400 or at least one circuit element constituting the driving devices 200, 300 and 400 may be positioned outside the single chip.

As shown in FIG. 2, the organic light emitting device according to the exemplary embodiment includes a substrate 110, and a display unit 113. The display unit 113 includes a plurality of pixels 112 arranged in a matrix format on the substrate 110. Each pixel 112 includes at least three subpixels 112R, 112G, and 112B. Although the pixel 112 includes the red, green, and blue subpixels 112R, 112G, and 112B in FIG. 2, the pixel 112 may include another subpixel emitting light of another color in addition to red, green, and blue light.

The pixel 112 receives a driving signal from a driver connected to signal lines 140 including the scan line, the data line and the power supply line. The driver includes the data driver 300 supplying a data signal to the pixel 112 and the scan driver 200 supplying a scan signal to the pixel 112.

The organic light emitting device includes a power supply unit 500 supplying a power to at least one of the pixel 112, the data driver 300, and the scan driver 200. The controller 400 supplies a control signal to at least one of the data driver 300, the scan driver 200, the power supply unit 500, or a switch unit 190.

As shown, the data driver 300 and the scan driver 200 are separately positioned on the substrate 110 outside the display unit 113. Further, the data driver 300 and the scan driver 200 may be positioned in an external device and may be electrically connected to the substrate 110.

Although the power supply unit 500 and the controller 400 are positioned on a circuit substrate 195 such as a printed circuit board (PCB) provided at the outside in FIG. 2, the exemplary embodiment is not limited thereto.

For reference, the substrate 110 and the circuit substrate 195 may be electrically connected to each other using a flexible cable 135 (for example, a flexible printed circuit (FPC)). The flexible cable 135 is attached to a pad unit 185 on the substrate 110, and the data and scan drivers 300 and 200 on the substrate 110 supply driving signal to the pixel 112 through the flexible cable 135.

The plurality of switch units 190 are positioned in each space between one output terminal of the data driver 300 and at least two subpixels. The plurality of switch units 190 can perform switch operations in response to the control signal output from the controller 400.

The exemplary embodiment has described the case that the plurality of switch units 190 are positioned in each space between one output terminal of the data driver 300 and at least three subpixels 112R, 112G, and 112B for the convenience of explanation, as an example.

Accordingly, data signals output from the output terminal of the data driver 300 are respectively supplied to at least three subpixels 112R, 112G, and 112B through switch operations of the plurality of switch units 190. For this, the data driver 300 may further include a line buffer that separately stores each of data signals (Data R, Data B, Data G) and successively outputs the data signals.

The plurality of switch units 190 may be positioned inside the data driver 300, or on the substrate 110 between the data driver 300 and the display unit 113.

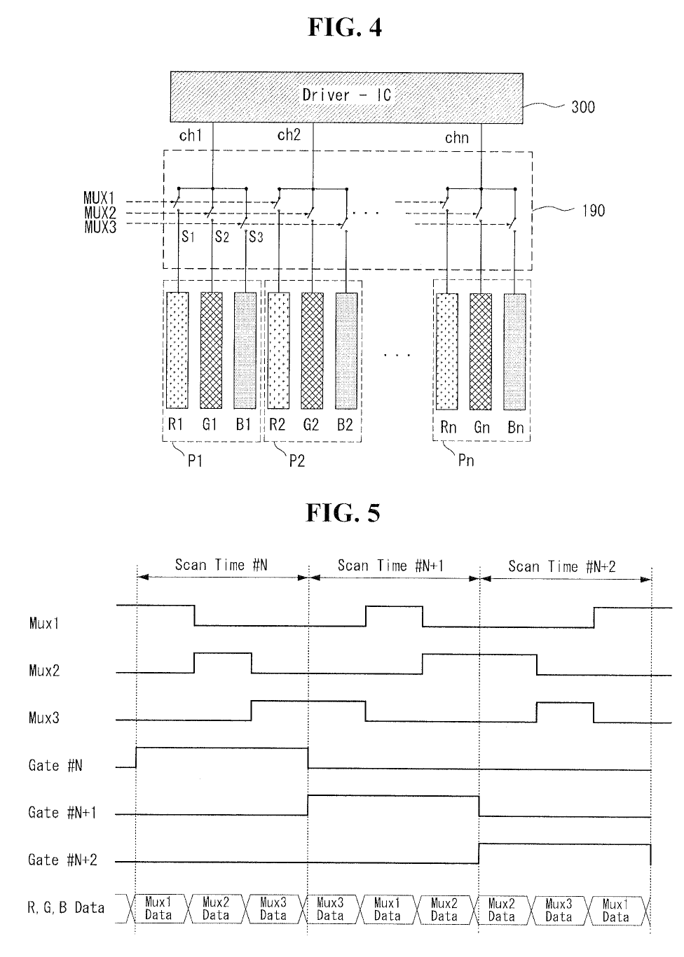

FIG. 4 is a circuit diagram showing a structure of a plurality of switch units between a data driver and a pixel.

As shown in FIG. 4, the plurality of switch units 190 are positioned in each space between one output terminal of the data driver 300 and three subpixels, respectively. For instance, the switch unit 190 is positioned between one output terminal ch1 of the data driver 300 and three subpixels R1, G1, and B1. Each switch unit 190 includes first, second and third switches S1, S2, and S3.

The plurality of switches of each switch unit 190 individually perform switch operations in response to control signals MUX1, MUX2, and MUX3 output from the controller 400. Data signals output from the output terminal ch1 of the data driver 300 are supplied to the three subpixels R1, G1, and B1, respectively.

The first, second and third switches S1, S2, and S3 are positioned on each pixel including three subpixels. For instance, the first, second and third switches S1, S2, and S3 are positioned on a pixel P1 including the three subpixels R1, G1, and B1.

When the plurality of switch units 190 perform switch operations, data signals output from a plurality of output terminals (ch1, ch2, . . . , chn) of the data driver 300 are supplied to three subpixels (R1, G1, B1, . . . , Rn, Gn, Bn) included in each of pixels (P1, P2, . . . , Pn), respectively.

The controller 400 supplies the control signals MUX1, MUX2, and MUX3 to each of the plurality of switch units 190. In this case, the controller 400 supplies the control signals so that one of the plurality of switches of each switch unit 190 performs one switch operation during two scan periods.

The controller 400 supplies the control signals MUX1, MUX2, and MUX3 so that the data signals output from the output terminal ch1 of the data driver 300 do not overlap each other and supply to the three subpixels R1, G1, and B1, respectively. In other words, the controller 400 controls the plurality of switch units 190 so that the plurality of switches of each switch unit 190 individually perform switch operations during one scan period when one scan signal is supplied to one row of the display unit.

FIG. 5 is a diagram showing a first example of a driving waveform.

FIG. 5 shows a case that the control signals MUX1, MUX2, and MUX3 are successively supplied so that the first, second and third switches of each switch unit successively perform switch operations in the order named during an n-th scan period (Scan Time #N) when a scan signal is supplied to an n-th row (Gate #N) of the display unit.

In FIG. 5, the controller 400 supplies the control signal MUX3 to the switch unit so that the last switched third switch during the n-th scan period (Scan Time #N) continuously performs a switch operation during a portion of an (n+1)-th scan period (Scan Time #N+1) when a scan signal is supplied to an (n+1)-th row (Gate #N+1) of the display unit. Hence, the third switch once performs the switch operation during the n-th scan period (Scan Time #N) and the portion of the (n+1)-th scan period (Scan Time #N+1).

In other words, the third switch is once turned on during the two scan periods (Scan Time #N and Scan Time #N+1), and thus supplies a data signal (Mux3 Data) to a subpixel corresponding to the n-th row (Gate #N). Then, the third switch is continuously maintained in a turn-on state, and thus supplies the data signal (Mux3 third switch is turned off.

Since the first and second switches individually perform the switch operations before the switch operation of the third switch, the data signal (Mux3 Data) is supplied after the supply of each corresponding data signal (Mux1 Data and Mux2 Data) to each corresponding subpixel.

The data signals (Mux1 Data, Mux2 Data, and Mux3 Data) are turned on/off in response to the control signals MUX1, MUX2, and MUX3, and then supplied to each corresponding subpixel.

Afterwards, the controller 400 supplies the control signals MUX1 and MUX2 to the switch unit so that after the switch operation of the third switch the first and second switches individually perform switch operations. In this case, the control signal MUX2 is operated so that the last switched second switch during the (n+1)-th scan period (Scan Time #N+1) continuously performs the switch operation during a portion of an (n+2)-th scan period (Scan Time #N+2).

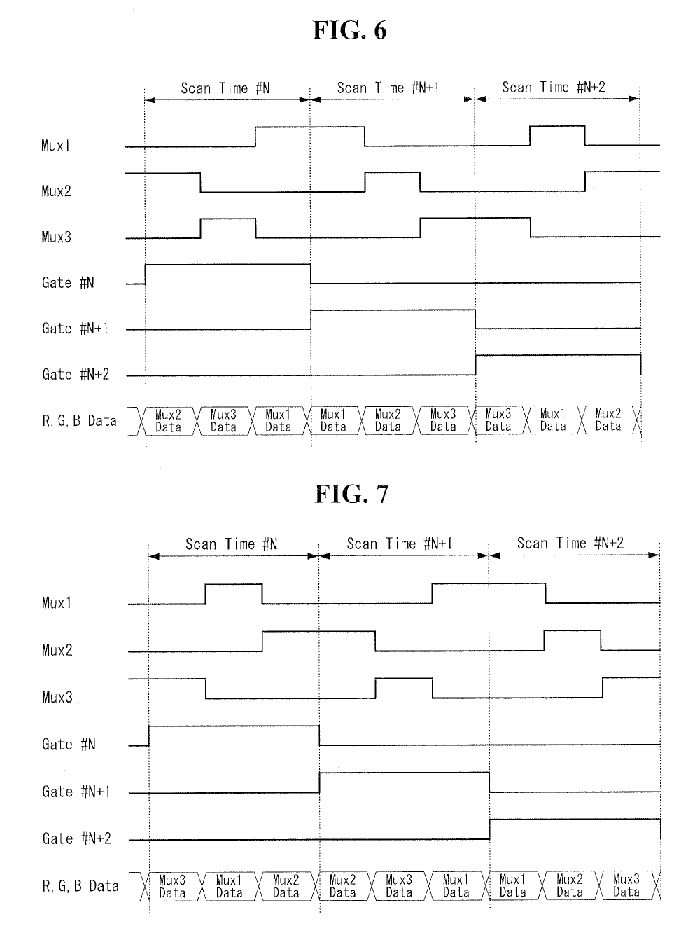

FIG. 6 is a diagram showing a second example of a driving waveform.

FIG. 6 shows a case that the control signals MUX2, MUX3, and MUX1 are successively supplied so that the second, third and first switches of each switch unit successively perform switch operations in the order named during the n-th scan period (Scan Time #N).

In FIG. 6, the controller 400 supplies the control signal MUX1 to the switch unit so that the last switched first switch during the n-th scan period (Scan Time #N) continuously performs a switch operation during a portion of the (n+1)-th scan period (Scan Time #N+1). Hence, the first switch once performs the switch operation during the n-th scan period (Scan Time #N) and the portion of the (n+1)-th scan period (Scan Time #N+1).

In other words, the first switch is once turned on during the two scan periods (Scan Time #N and Scan Time #N+1), and thus supplies a data signal (Mux1 Data) to a subpixel corresponding to the n-th row (Gate #N). Then, the first switch is continuously maintained in a turn-on state, and thus supplies the data signal (Mux1 Data) to a subpixel corresponding to the (n+1)-th row (Gate #N+1). Afterwards, the first switch is turned off.

Since the second and third switches individually perform the switch operations before the switch operation of the first switch, the data signal (Mux1 Data) is supplied after the supply of each corresponding data signal (Mux2 Data and Mux3 Data) to each corresponding subpixel.

The data signals (Mux1 Data, Mux2 Data, and Mux3 Data) are turned on/off in response to the control signals MUX1, MUX2, and MUX3, and then supplied to each corresponding subpixel.

Afterwards, the controller 400 supplies the control signals MUX2 and MUX3 to the switch unit so that after the switch operation of the first switch the second and third switches individually perform switch operations. In this case, the control signal MUX3 is operated so that the last switched third switch during the (n+1)-th scan period (Scan Time #N+1) continuously performs the switch operation during a portion of the (n+2)-th scan period (Scan Time #N+2).

FIG. 7 is a diagram showing a third example of a driving waveform.

FIG. 7 shows a case that the control signals MUX3, MUX1, and MUX2 are successively supplied so that the third, first and second switches of each switch unit successively perform switch operations in the order named during the n-th scan period (Scan Time #N).

In FIG. 7, the controller 400 supplies the control signal MUX2 to the switch unit so that the last switched second switch during the n-th scan period (Scan Time #N) continuously performs a switch operation during a portion of the (n+1)-th scan period (Scan Time #N+1). Hence, the second switch once performs the switch operation during the n-th scan period (Scan Time #N) and the portion of the (n+1)-th scan period (Scan Time #N+1).

In other words, the second switch is once turned on during the two scan periods (Scan Time #N and Scan Time #N+1), and thus supplies a data signal (Mux2 Data) to a subpixel corresponding to the n-th row (Gate #N). Then, the second switch is continuously maintained in a turn-on state, and thus supplies the data signal (Mux2 Data) to a subpixel corresponding to the (n+1)-th row (Gate #N+1). Afterwards, the first switch is turned off.

Since the third and first switches individually perform the switch operations before the switch operation of the second switch, the data signal (Mux2 Data) is supplied after the supply of each corresponding data signal (Mux3 Data and Mux1 Data) to each corresponding subpixel.

The data signals (Mux1 Data, Mux2 Data, and Mux3 Data) are turned on/off in response to the control signals MUX1, MUX2, and MUX3, and then supplied to each corresponding subpixel.

Afterwards, the controller 400 supplies the control signals MUX3 and MUX1 to the switch unit so that after the switch operation of the second switch the third and first switches individually perform switch operations. In this case, the control signal MUX1 is operated so that the last switched first switch during the (n+1)-th scan period (Scan Time #N+1) continuously performs the switch operation during a portion of the (n+2)-th scan period (Scan Time #N+2).

According to the above-described first, second, and third example diagrams, in case that a Mux driving manner is adopted, the first, second, and third switches individually perform switch operations in response to the control signals MUX1, MUX2, and MUX3, and one of the first, second, and third switches continuously performs the switch operation during two scan periods. Hence, one turn-on/off operation is reduced in every scan period.

For this, as shown in the first, second, and third example diagrams, every time the scan line of the scan signal changes, the controller 400 supplies the control signals so that a case (a) where the first, second, and third switches individually perform switch operations in the order named, a case (b) where the third, first, and second switches individually perform switch operations in the order named, and a case (c) where the second, third, and first switches individually perform switch operations in the order named are carried out. In this case, the cases (a), (b), and (c) may be carried out in no particular order. Accordingly, every time the first, second, and third switches individually perform switch operations, at least three subpixels receive R, G, and B data signals from the data driver 300, respectively.

The controller 400 may control a ratio of the control signal to be 1:1:1 so that all the first, second, and third switches individually perform switch operations during one scan period.

Although the exemplary embodiment has illustrated and described the case where the scan signal is continuously supplied during one scan period, it is not limited thereto. The scan signal may not be supplied during a predetermined time interval of one scan period. In other words, it is possible to stop the supply of the scan signal during a predetermined time interval of one scan period.

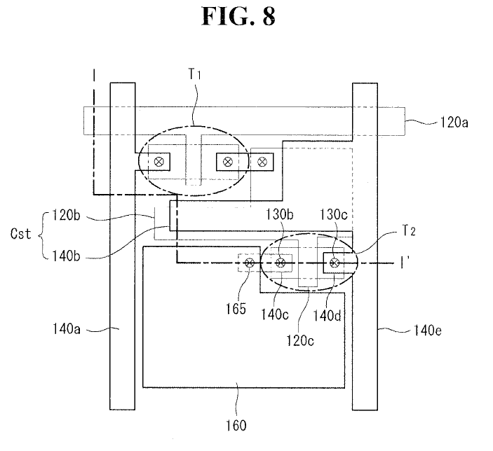

FIG. 8 is a plane view showing a structure of a subpixel of the organic light emitting device.

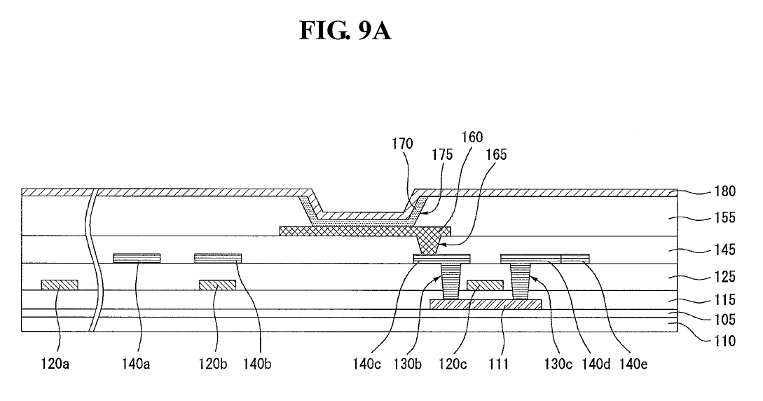

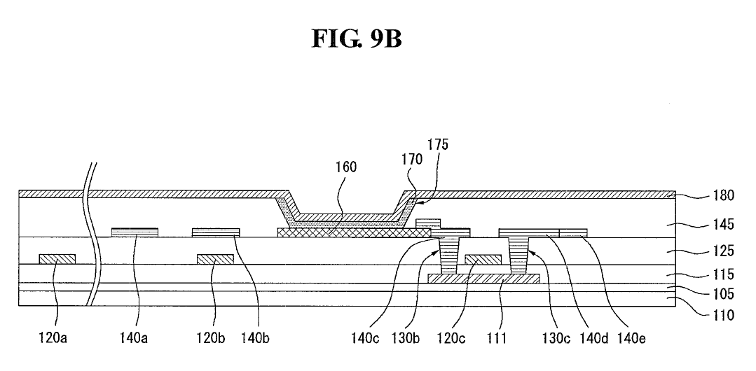

FIGS. 8, 9A and 9B show a structure of the subpixel of the organic light emitting device according to the exemplary embodiment. This structure includes the substrate 110 having a plurality of subpixel and non-subpixel areas. As shown, for instance, in FIG. 8, the subpixel area and the non-subpixel area may be defined by a scan line 120a that extends in one direction, a data line 140a that extends substantially perpendicular to the scan line 120a, and a power supply line 140e that extends substantially parallel to the data line 140a.

The subpixel area may include a switching thin film transistor T1 connected to the scan line 120a and the data line 140a, a capacitor Cst connected to the switching thin film transistor T1 and the power supply line 140e, and a driving thin film transistor T2 connected to the capacitor Cst and the power supply line 140e. The capacitor Cst may include a capacitor lower electrode 120b and a capacitor upper electrode 140b.

The subpixel area may also include a light emitting diode, which includes a first electrode 160 electrically connected to the driving thin film transistor T2, a light emitting layer (not shown) on the first electrode 160, and a second electrode (not shown). The non-subpixel area may include the scan line 120a, the data line 140a and the power supply line 140e.

FIGS. 9A and 9B are cross-sectional views taken along line I-I′ of FIG. 8.

As shown in FIG. 9A, a buffer layer 105 is positioned on the substrate 110. The buffer layer 105 prevents impurities (e.g., alkali ions discharged from the substrate 110) from being introduced during formation of the thin film transistor in a succeeding process. The buffer layer 105 may be selectively formed using silicon oxide (SiO2), silicon nitride (SiNX), or using other materials. The substrate 110 may be formed of glass, plastic or metal.

A semiconductor layer 111 is positioned on the buffer layer 105. The semiconductor layer 111 may include amorphous silicon or crystallized polycrystalline silicon. The semiconductor layer 111 may include a source region and a drain region including p-type or n-type impurities. The semiconductor layer 111 may include a channel region in addition to the source region and the drain region.

A first insulating layer 115, which may be a gate insulating layer, is positioned on the semiconductor layer 111. The first insulating layer 115 may include a silicon oxide (SiO_{X}) layer, a silicon nitride (SiN_{X}) layer, or a multi-layered structure or a combination thereof.

A gate electrode 120c is positioned on the first insulating layer 115 in a given area of the semiconductor layer 111, e.g., at a location corresponding to the channel region of the semiconductor layer 111 when impurities are doped. The scan line 120a and the capacitor lower electrode 120b may be positioned on the same formation layer as the gate electrode 120c.

The gate electrode 120c may be formed of any one selected from the group consisting of molybdenum (Mo), aluminum (Al), chromium (Cr), gold (Au), titanium (Ti), nickel (Ni), neodymium (Nd) and copper (Cu), or a combination thereof. The gate electrode 120c may have a multi-layered structure formed of Mo, Al, Cr, Au, Ti, Ni, Nd, or Cu, or a combination thereof. The gate electrode 120c may have a double-layered structure including Mo/Al—Nd or Mo/Al.

The scan line 120a may be formed of any one selected from the group consisting of Mo, Al, Cr, Au, Ti, Ni, Nd, or Cu, or a combination thereof. The scan line 120a may have a multi-layered structure formed of Mo, Al, Cr, Au, Ti, Ni, Nd, or Cu, or a combination thereof. The scan line 120a may have a double-layered structure including Mo/Al—Nd or Mo/Al.

A second insulating layer 125, which may be an interlayer dielectric, is positioned on the substrate 110 on which the scan line 120a, the capacitor lower electrode 120b and the gate electrode 120c are positioned. The second insulating layer 125 may include a silicon oxide (SiO_{X}) layer, a silicon nitride (SiN_{X}) layer, or a multi-layered structure or a combination thereof.

Contact holes 130b and 130c are positioned inside the second insulating layer 125 and the first insulating layer 115 to expose a portion of the semiconductor layer 111.

A drain electrode 140c and a source electrode 140d are positioned in the contact holes 130b and 130c passing through the second insulating layer 125 and the first insulating layer 115.

The drain electrode 140c and the source electrode 140d may have a single-layered structure or a multi-layered structure. When the drain electrode 140c and the source electrode 140d have the single-layered structure, the drain electrode 140c and the source electrode 140d may be formed of Mo, Al, Cr, Au, Ti, Ni, Nd, or Cu, or a combination thereof.

When the drain electrode 140c and the source electrode 140d have the multi-layered structure, the drain electrode 140c and the source electrode 140d may have a double-layered structure including Mo/Al—Nd or a triple-layered structure including Mo/Al/Mo or Mo/Al—Nd/Mo.

The data line 140a, the capacitor upper electrode 140b, and the power supply line 140e may be positioned on the same formation layer as the drain electrode 140c and the source electrode 140d.

The data line 140a and the power supply line 140e positioned in the non-subpixel area may have a single-layered structure or a multi-layered structure. When the data line 140a and the power supply line 140e have the single-layered structure, the data line 140a and the power supply line 140e may be formed of Mo, Al, Cr, Au, Ti, Ni, Nd, or Cu, or a combination thereof.

When the data line 140a and the power supply line 140e have the multi-layered structure, the data line 140a and the power supply line 140e may have a double-layered structure including Mo/Al—Nd or a triple-layered structure including Mo/Al/Mo or Mo/Al—Nd/Mo. The data line 140a and the power supply line 140e may have a triple-layered structure including Mo/Al—Nd/Mo.

A third insulating layer 145 is positioned on the data line 140a, the capacitor upper electrode 104b, the drain electrode 140c, the source electrode 140d, and the power supply line 140e. The third insulating layer 145 may be a planarization layer for obviating the height difference of a lower structure. The third insulating layer 145 may be formed using a method such as spin on glass (SOG) obtained by coating an organic material such as polyimide, benzocyclobutene-based resin and acrylate in the liquid form and then hardening it. Further, an inorganic material such a silicone oxide may be used. Otherwise, the third insulating layer 145 may be a passivation layer, and may include a silicon oxide (SiO_{X}) layer, a silicon nitride (SiN_{X}) layer, or a multi-layered structure including a combination thereof.

A via hole 165 is positioned inside the third insulating layer 145 to expose any one of the source and drain electrodes 140c and 140d. The first electrode 160 is positioned on the third insulating layer 145 to be electrically connected to any one of the source and drain electrodes 140c and 140d via the via hole 165.

The first electrode 160 may be an anode electrode. In case that the organic light emitting device has a bottom emission or dual emission structure, the first electrode 160 may be formed of a transparent material such as indium-tin-oxide (ITO), indium-zinc-oxide (IZO), or zinc oxide (ZnO). In case that the organic light emitting device has a top emission structure, the first electrode 160 may include a layer formed of one of ITO, IZO or ZnO, and a reflective layer formed of one of Al, Ag or Ni under the layer. Further, the first electrode 160 may have a multi-layered structure in which the reflective layer is positioned between two layers formed of one of ITO, IZO or ZnO.

A fourth insulating layer 155 including an opening 175 is positioned on the first electrode 160. The opening 175 provides electrical insulation between the neighboring first electrodes 160 and exposes a portion of the first electrode 160. A light emitting layer 170 is positioned on the first electrode 160 exposed by the opening 175.

A second electrode 180 is positioned on the light emitting layer 170. The second electrode 180 may be a cathode electrode, and may be formed of Mg, Ca, Al and Ag having a low work function or a combination thereof. In case that the organic light emitting device has a top emission or dual emission structure, the second electrode 180 may be thin enough to transmit light. In case that the organic light emitting device has a bottom emission structure, the second electrode 180 may be thick enough to reflect light.

The organic light emitting device according to the exemplary embodiment using a total of 7 masks was described as an example. The 7 masks may be used in a process for forming each of the semiconductor layer, the gate electrode (including the scan line and the capacitor lower electrode), the contact holes, the source and drain electrodes (including the data line, the power supply line and the capacitor upper electrode), the via holes, the first electrode, and the opening.

An example of how an organic light emitting device is formed using a total of masks will now be given.

As shown in FIG. 9B, the buffer layer 105 is positioned on the substrate 100, and the semiconductor layer 111 is positioned on the buffer layer 105. The first insulating layer 115 is positioned on the semiconductor layer 111. The gate electrode 120c, the capacitor lower electrode 120b, and the scan line 120a are positioned on the first insulating layer 115. The second insulating layer 125 is positioned on the gate electrode 120c.

The first electrode 160 is positioned on the second insulating layer 125, and the contact holes 130b and 130c are positioned to expose the semiconductor layer 111. The first electrode 160 and the contact holes 130b and 130c may be simultaneously formed.

The source electrode 140d, the drain electrode 140c, the data line 140a, the capacitor upper electrode 140b, and the power supply line 140e are positioned on the second insulating layer 125. A portion of the drain electrode 140c may be positioned on the first electrode 160.

A pixel or subpixel definition layer or the third insulating layer 145, which may be a bank layer, is positioned on the substrate 110 on which the above-described structure is formed. The opening 175 is positioned on the third insulating layer 145 to expose the first electrode 160. The light emitting layer 170 is positioned on the first electrode 160 exposed by the opening 175, and the second electrode 180 is positioned on the light emitting layer 170.

The aforementioned organic light emitting device can be manufactured using a total of 5 masks. The 5 masks are used in a process for forming each of the semiconductor layer, the gate electrode (including the scan line and the capacitor lower electrode), the first electrode (including the contact holes), the source and drain electrodes (including the data line, the power supply line and the capacitor upper electrode), and the opening. Accordingly, the organic light emitting device according to the exemplary embodiment can reduce the manufacturing cost by a reduction in the number of masks and can improve the efficiency of mass production.

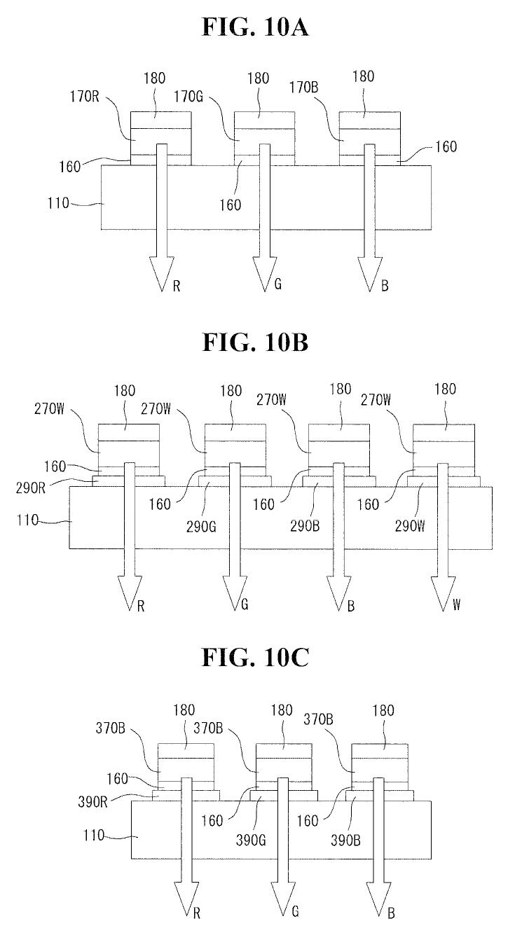

Various color image display methods may be implemented in the organic light emitting device such as described above. These methods will be described below with reference to FIGS. 10A to 10C.

FIGS. 10A to 10C illustrate various implementations of a color image display method in the organic light emitting device.

FIG. 10A illustrates a color image display method in an organic light emitting device that separately includes a red light emitting layer 170R to emit red light, a green light emitting layer 170G to emit green light, and a blue light emitting layer 170B to emit blue light. The red, green and blue light produced by the red, green and blue light emitting layers 170R, 170G and 170B is mixed to display a color image.

In FIG. 10A, the red, green and blue light emitting layers 170R, 170G and 170B may each include an electron transport layer, a hole transport layer, and the like. It is possible to variously change an arrangement and a structure between additional layers such as the electron transport layer and the hole transport layer and each of the red, green and blue light emitting layers 170K, 170G and 170B.

FIG. 10B illustrates a color image display method in an organic light emitting device including a white light emitting layer 270W, a red color filter 290R, a green color filter 290G, a blue color filter 290B, and a white color filter 290W.

As shown in FIG. 10B, the red color filter 290R, the green color filter 290G, the blue color filter 290B, and the white color filter 290W each transmit white light produced by the white light emitting layer 270W and produce red light, green light, blue light, and white light. The red, green, blue, and white light is mixed to display a color image. The white color filter 290W may be removed depending on color sensitivity of the white light produced by the white light emitting layer 270W and combination of the white light and the red, green and blue light.

While FIG. 10B has illustrated the color display method of four subpixels using combination of the red, green, blue, and white light, a color display method of three subpixels using combination of the red, green, and blue light may be used.

In FIG. 10B, the white light emitting layer 270W may include an electron transport layer, a hole transport layer, and the like. It is possible to variously change an arrangement and a structure between additional layers such as the electron transport layer and the hole transport layer and the white light emitting layer 270W.

FIG. 10C illustrates a color image display method in an organic light emitting device including a blue light emitting layer 370B, a red color change medium 390R, a green color change medium 390G, and a blue color change medium 390B.

As shown in FIG. 10C, the red color change medium 390R, the green color change medium 390G, and the blue color change medium 390B each transmit blue light produced by the blue light emitting layer 370B to produce red light, green light and blue light. The red, green and blue light is mixed to display a color image.

The blue color change medium 390B may be removed depending on color sensitivity of the blue light produced by the blue light emitting layer 370B and combination of the blue light and the red and green light.

In FIG. 10C, the blue light emitting layer 370B may include an electron transport layer, a hole transport layer, and the like. It is possible to variously change an arrangement and a structure between additional layers such as the electron transport layer and the hole transport layer and the blue light emitting layer 370B.

While FIGS. 10A to 10C have illustrated and described the organic light emitting device having a bottom emission structure, the exemplary embodiment is not limited thereto. The display device according to the exemplary embodiment may have a top emission structure, and thus can a different arrangement and a different structure depending on the top emission structure.

While FIGS. 10A to 10C have illustrated and described three kinds of color image display method, the exemplary embodiment is not limited thereto. The exemplary embodiment may use various kinds of color image display method whenever necessary.

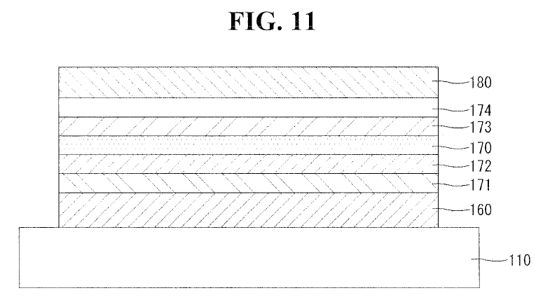

FIG. 11 is a cross-sectional view of the organic light emitting device.

As shown in FIG. 11, the organic light emitting device according to the exemplary embodiment includes the substrate 110, the first electrode 160 on the substrate 110, a hole injection layer 171 on the first electrode 160, a hole transport layer 172, a light emitting layer 170, an electron transport layer 173, an electron injection layer 174, and the second electrode 180 on the electron injection layer 174.

The hole injection layer 171 may function to facilitate the injection of holes from the first electrode 160 to the light emitting layer 170. The hole injection layer 171 may be formed of at least one selected from the group consisting of copper phthalocyanine (CuPc), PEDOT(poly(3,4)-ethylenedioxythiophene), polyaniline (PANI) and NPD(N,N-dinaphthyl-N,N′-diphenyl benzidine), but is not limited thereto. The hole injection layer 171 may be formed using an evaporation method or a spin coating method.

The hole transport layer 172 functions to smoothly transport holes. The hole transport layer 172 may be formed from at least one selected from the group consisting of NPD(N,N-dinaphthyl-N,N′-diphenyl benzidine), TPD(N,N′-bis-(3-methylphenyl)-N,N′-bis-(phenyl)-benzidine, s-TAD and MTDATA(4,4′,4″-Tris(N-3-methylphenyl-N-phenyl-amino)-triphenylamine), but is not limited thereto. The hole transport layer 172 may be formed using an evaporation method or a spin coating method.

The light emitting layer 170 may be formed of a material capable of producing red, green, blue and white light, for example, a phosphorescence material or a fluorescence material.

In case that the light emitting layer 170 produces red light, the light emitting layer 170 includes a host material including carbazole biphenyl (CBP) or N,N-dicarbazolyl-3,5-benzene (mCP). Further, the light emitting layer 170 may be formed of a phosphorescence material including a dopant material including any one selected from the group consisting of PIQIr(acac)(bis(1-phenylisoquinoline)acetylacetonate iridium), PQIr(acac)(bis(1-phenylquinoline)acetylacetonate iridium), PQIr(tris(1-phenylquinoline)iridium) and PtOEP(octaethylporphyrin platinum) or a fluorescence material including PBD:Eu(DBM)3(Phen) or Perylene, but is not limited thereto.

In case that the light emitting layer 170 produces green light, the light emitting layer 170 includes a host material including CBP or mCP. Further, the light emitting layer 170 may be formed of a phosphorescence material including a dopant material including Ir(ppy)3(fac tris(2-phenylpyridine)iridium) or a fluorescence material including Alq3(tris(8-hydroxyquinolino)aluminum), but is not limited thereto.

In case that the light emitting layer 170 produces blue light, the light emitting layer 170 includes a host material including CBP or mCP. Further, the light emitting layer 170 may be formed of a phosphorescence material including a dopant material including (4,6-F2 ppy)2Irpic or a fluorescence material including any one selected from the group consisting of spiro-DPVBi, spiro-6P, distyryl-benzene (DSB), distyryl-arylene (DSA), PFO-based polymers, PPV-based polymers and a combination thereof, but is not limited thereto.

The electron transport layer 173 functions to facilitate the transportation of electrons. The electron transport layer 173 may be formed of at least one selected from the group consisting of Alq3(tris(8-hydroxyquinolino)aluminum, PBD, TAZ, spiro-PBD, BAlq, and SAlq, but is not limited thereto. The electron transport layer 173 may be formed using an evaporation method or a spin coating method.

The electron transport layer 173 can also function to prevent holes, which are injected from the first electrode 160 and then pass through the light emitting layer 170, from moving to the second electrode 180. In other words, the electron transport layer 173 serves as a hole stop layer, which facilitates the coupling of holes and electrons in the light emitting layer 170.

The electron injection layer 174 functions to facilitate the injection of electrons. The electron injection layer 174 may be formed of Alq3(tris(8-hydroxyquinolino)aluminum), PBD, TAZ, spiro-PBD, BAlq or SAlq, but is not limited thereto. The electron injection layer 174 may be formed of an organic material and an inorganic material forming the electron injection layer 174 through a vacuum evaporation method.

The hole injection layer 171 or the electron injection layer 174 may further include an inorganic material. The inorganic material may further include a metal compound. The metal compound may include alkali metal or alkaline earth metal. The metal compound including the alkali metal or the alkaline earth metal may include at least one selected from the group consisting of LiQ, LiF, NaF, KF, RbF, CsF, FrF, BeF₂, MgF₂, CaF₂, SrF₂, BaF₂, and RaF₂, but is not limited thereto.

Thus, the inorganic material inside the electron injection layer 174 facilitates hopping of electrons injected from the second electrode 180 to the light emitting layer 170, so that holes and electrons injected into the light emitting layer 170 are balanced. Accordingly, the light emission efficiency can be improved.

Further, the inorganic material inside the hole injection layer 171 reduces the mobility of holes injected from the first electrode 160 to the light emitting layer 170, so that holes and electrons injected into the light emitting layer 170 are balanced. Accordingly, the light emission efficiency can be improved.

At least one of the electron injection layer 174, the electron transport layer 173, the hole transport layer 172, the hole injection layer 171 may be omitted.

As described above, since the data driver of the organic light emitting device according to the exemplary embodiment includes the switch unit at the output terminal of the data driver, stress applied to the switch unit can be reduced by reducing the number of switch operations in the switch unit. Hence, the reliability of the switch operations of the switch unit can be improved. Further, the display quality of the organic light emitting device according to the exemplary embodiment can be improved by efficiently supplying the data signal to each subpixel.

The foregoing embodiments and advantages are merely exemplary and are not to be construed as limiting the present invention. The present teaching can be readily applied to other types of apparatuses. The description of the foregoing embodiments is intended to be illustrative, and not to limit the scope of the claims. Many alternatives, modifications, and variations will be apparent to those skilled in the art.

What is claimed is:

1. An organic light emitting device comprising:
a display unit including a pixel including a plurality of subpixels;
a scan driver that is connected to the display unit to supply a scan signal to the pixel during a scan period;
a data driver that is connected to the display unit to supply a data signal to the subpixels;
a switch unit positioned between one output terminal of the data driver and the subpixels, the switch unit including a plurality of switches, wherein one of the plurality of switches is turned on during an n-th scan period, maintained in a turn-on state, and turned off during an (n+1)-th scan period; and
a controller that supplies a control signal for controlling turn-on/off operations of the switch unit to the switch unit.

2. The organic light emitting device of claim 1, wherein the plurality of subpixels each emit different color light.

3. The organic light emitting device of claim 1, wherein the plurality of switches are individually turned on during the scan period.

4. The organic light emitting device of claim 1, wherein the switch unit includes first, second, and third switches, and
when the first, second, and third switches are successively turned on in the order named during the n-th scan period, the third switch is continuously maintained in a turn-on state and turned off during the (n+1)-th scan period.

5. The organic light emitting device of claim 1, wherein the switch unit includes first, second, and third switches, and
when the second, third, and first switches are successively turned on in the order named during the n-th scan period, the first switch is continuously maintained in a turn-on state and turned off during the (n+1)-th scan period.

6. The organic light emitting device of claim 1, wherein the switch unit includes first, second, and third switches, and
when the third, first, and second switches are successively turned on in the order named during the n-th scan period, the second switch is continuously maintained in a turn-on state and turned off during the (n+1)-th scan period.

7. The organic light emitting device of claim 3, wherein while the plurality of switches are individually turned on, the data driver supplies the data signal to the subpixels.

8. The organic light emitting device of claim 1, wherein each subpixel includes at least one capacitor, at least one transistor, and a light emitting diode.

9. The organic light emitting device of claim 3, wherein the amount of time required to turn on and then turn off each of the plurality of switches during the scan period is substantially equal to each other.

10. The organic light emitting device of claim 2, wherein the number of subpixels is three.

11. A method of driving an organic light emitting device comprising:
supplying a scan signal to a pixel including a plurality of subpixels during a scan period;
supplying a plurality of control signals for selecting each of the plurality of subpixels during the scan period; and
supplying a data signal to the subpixels while the plurality of control signals is supplied to the subpixels,
wherein one of the plurality of control signals is continuously supplied to the subpixels during an n-th scan period and an (n+1)-th scan period.

12. The method of claim 11, wherein the plurality of subpixels each emit different color light.

13. The method of claim 11, wherein the plurality of control signals are individually supplied to the subpixels during the scan period.

14. The method of claim 11, wherein the plurality of control signals include first, second, and third control signals, and
when the first, second, and third control signals are successively supplied to the subpixels in the order named during the n-th scan period, the third control signal is continuously supplied to the subpixels during the n-th and (n+1)-th scan periods.

15. The method of claim 11, wherein the plurality of control signals include first, second, and third control signals, and
when the second, third, and first control signals are successively supplied to the subpixels in the order named during the n-th scan period, the first control signal is continuously supplied to the subpixels during the n-th and (n+1)-th scan periods.

16. The method of claim 11, wherein the plurality of control signals include first, second, and third control signals, and
when the third, first, and second control signals are successively supplied to the subpixels in the order named during the n-th scan period, the second control signal is continuously supplied to the subpixels during the n-th and (n+1)-th scan periods.

17. The method of claim 12, wherein the plurality of control signals include first, second, and third control signals, and the first, second, and third control signals each are supplied for a substantially equal time interval of the scan period.

18. The method of claim 2, wherein the number of subpixels is three.
